(19) United States
(12) Patent Application Publication
(10) Pub. No.: US 2009/0151528 A1
(43) Pub. Date: Jun. 18, 2009

(54) Office accessory for processing sheet material

(76) Inventor: Bernd LOIBL, (US)

Correspondence Address: BERENATO, WHITE & STAVISH, LLC, 6550 ROCK SPRING DRIVE, SUITE 240, BETHESDA, MD, 20817, US

(21) Appl. No.: 12/268,645

(22) Filed: Nov. 11, 2008

(30) Foreign Application Priority Data
Nov. 14, 2007 (DE) 202007015981.1

(51) Int. Cl. B26D 7/01; B26D 5/08; B26F 1/14

(52) U.S. Cl. 83/468; 83/613; 83/684

(57) ABSTRACT

The invention relates to an office accessory (1) for processing sheet material (4), having a bed (2) for receiving the sheet material (4), having at least one stop (3a) for positionally accurate positioning of the sheet material (4), and having a punching apparatus (6), the bed (2) and punching apparatus (6) comprising complementary engagement elements (5) for reproducible positioning of the punching apparatus (6) in different punching positions in the region of the stop (3a), which is characterized in that the office accessory (1) comprises at least one cutting device (8) for trimming the sheet material (4).

### CROSS-REFERENCE TO RELATED APPLICATIONS AND CLAIM TO PRIORITY

This application is related to utility model application no. 20 2007 015 981.1, filed Nov. 14, 2007 in the Federal Republic of Germany, to which priority is claimed.

### FIELD OF THE INVENTION

The present invention relates to an office accessory for processing sheet material, having a bed for receiving the sheet material, having at least one stop for positionally accurate positioning of the sheet material, and having at least one punching apparatus, the bed and punching apparatus comprising complementary engagement elements for reproducible positioning of the punching apparatus in different punching positions in the region of the stop.

### BACKGROUND OF THE INVENTION

Office accessories of the kind cited above are known, for example, from DE 3 227 301 C2. They serve for hole-punching of paper sheet material, usually in the DIN A4 format. Unpunched sheets of paper are usually hole-punched by firstly folding them into a two-layer arrangement and then placing them into a hole punch, and then hole-punching them. For this purpose, often the center of the folded sheet is first identified, and is then placed against a positioning marking of the hole punch. Alternatively, a hole punch of this kind is equipped with a laterally mounted bar against which the lower edge of the sheet of paper to be hole-punched is placed for positioning of the sheet in the hole punch. If the sheet of paper is then also to be trimmed to a specific dimension, it is necessary to remove from the hole punch the sheet material that has already been aligned for hole-punching, place it into a separate office accessory having a cutting device, and align it again along a cutting edge of the cutting device.

### SUMMARY OF THE INVENTION

It is therefore an object of the present invention to make available an office accessory of the kind cited initially that simplifies handling by reducing the necessary working steps.

This object is achieved, according to the present invention, in that the office accessory comprises at least one cutting device for cutting the sheet material. In other words, the combination of punching apparatus and cutting device in one office accessory makes it possible for the sheet material being processed to require alignment only a single time, so that it can then be both hole-punched and trimmed to a specific dimension in reproducible fashion.

The cutting device can be embodied as a guillotine cutting device, a rotary cutting device, or a blade cutter. It is of course also possible to provide multiple cutting devices and, in that context, to mount a combination of a guillotine and rotary cutting device. It is of course also possible to provide multiple cutting devices and, in that context, to mount a combination of a guillotine, blade, and rotary cutting device.

In an exemplifying embodiment of the present invention, a holddown for pressing the sheet material onto the sheet-material support surface is to be arranged alongside the cutting device, the holddown being movable between a raised starting position and a pressing position offset toward the bed. A holddown of this kind is described, for example, in EP 1 754 578 A1, to the entirety of which reference is hereby mad

To allow the sheet material to be provided with edges that extend parallel, it is useful to align the cutting device on the office accessory parallel to the stop.

In a further embodiment of the invention, the cutting device, or a further cutting device, is aligned perpendicular to the stop to allow the sheet material also to be trimmed at a right angle to the stop edge with no need, for that purpose, firstly to remove the sheet material from the office accessory and then put it back in place.

In a further embodiment of the invention, it is proposed that the cutting device be guided displaceably parallel to the stop, so that a spacing between the punched holes and cutting edge is settable. This spacing defines the edge length of the sheet material to be trimmed if the sheet material is not to be further displaced in the office accessory between the working steps. A setting of this kind of the spacing between the stop and cutting edge, and thus of an edge length of the sheet material, can also be accomplished by guiding the stop displaceably parallel to the cutting device.

For the case in which the sheet edge to be trimmed is embodied not parallel to the edge located at the stop but rather at a specific angle thereto, in a further exemplifying embodiment of the present invention the cutting device can be aligned relative to the stop at an angle that can be set and modified by way of an adjustment mechanism.

According to a further feature of the invention, as described e.g. in EP 1 475 201 B1, to the entirety of which reference is hereby made, provision is made that the cutting device is raisable out of a lower cutting position into an upper starting position, and is movable therefrom back into the cutting position. The gap between the bed and cutting device can be embodied to be inaccessible from the end faces of the cutting device. As a result it becomes possible not to carry out the vertical movement of the circular knife of the cutting device by way of a knife carriage provided on the cutting device, but rather to effect it by means of the cutting device itself, by firstly raising the cutting device in order to slide the sheet stock through, and then lowering it into the cutting position in which the circular knife rests on the bed. This makes handling of the cutting operation substantially simpler, and results in cleaner cuts. It is particularly important that the gap between the cutting device and bed be inaccessible from the end faces of the guide bar, i.e. be covered there, so that it is not possible for the operator's fingers to get into the gap in this region and become caught when the guide bar is lowered.

In a further embodiment of the invention, it is proposed that the guide bar be guided in vertically displaceable fashion in the region of its end faces, so that it can be raised and lowered parallel to the bed, preferably by no more than 20 mm, and even more preferably by an amount equal to 12 mm. Alternatively thereto, however, provision can also be made for the cutting device to be mounted pivotably about a horizontal axis in the region of one end face, through an angle at most of 10°, preferably of 4 to 5°.

The cutting device can be suspended in such a way that it assumes, without actuation, the cutting position in which the rotary knife rests on the bed. The cutting device can be raised manually in order to slide the sheet material through the gap between the cutting device and bed. Alternatively thereto, however, the possibility also exists that the cutting device is held, without actuation, in the starting position by means of a spring. This facilitates sliding of the sheet material through the gap, but requires the guide bar to be pushed down for the cutting operation. A clean cut is achieved with this embodiment as well, however, since it is possible to push down the guide bar with one hand and displace the knife carriage with the other hand; this is considerably easier to handle than with the known rotary cutting devices, in which the knife carriage must be pushed down and simultaneously displaced.

Provision is furthermore made according to the present invention that the guide bar is fastenable in the cutting position, at its vertically movable end(s), with a blocking device or devices. The guide bar is thereby immobilized for the cutting operation and cannot move by itself, and need not be pushed down during the cutting operation when that is counteracted by a spring. This simplifies operation of the cutting device.

The (or each) blocking device is preferably embodied as a snap device into which the cutting device snaps automatically and disengageably upon movement into the cutting position, so that immobilization of the guide bar in the cutting position is not associated with additional manipulations. Only for the disengagement operation after the cutting operation is an actuation of the snap device necessary, for the purpose of disengaging it. The snap device can comprise for that purpose an actuation slider that is mounted at a favorable location.

In a further embodiment of the invention, provision is made for embodying the complementary engagement elements of the office accessory as a separate component in a kind of template that is then insertable into a holder embodied in the office accessory. This has the advantage that for the case in which a different hole pattern for hole-punching of the sheet material, or use of a different punching apparatus in particular having different geometrical dimensions, is desired, the template can easily be exchanged and replaced by a different template having a different hole pattern.

To allow the sheet material to be trimmed to a specific size, in an advantageous embodiment of the present invention a measurement device is provided on the office accessory to determine the dimension of the sheet material.

The measurement device can be implemented by way of a ruler or a measuring roller having a length indicator. The ruler can be attached in fold-out fashion to the office accessory, thereby achieving particularly space-saving storage of the office accessory and simplified handling, for example, when the office accessory is transported.

In a further exemplifying embodiment of the present invention, the measurement device is mounted displaceably relative to the stop. This makes it possible to align the measurement device with the starting point of its scale against the sheet-material format being used, avoiding cumbersome conversion of the scale value in order to determine the edge length perpendicular to the cutting device that is obtained by displacement.

In a further embodiment of the present invention, at least one side stop is arranged on the bed of the office accessory for reproducible positioning of the sheet material in the office accessory. This side stop can be fastened in position or embodied displaceably. An embodiment of the present invention provides for embodying two side stops to the right and left of the sheet material to be inserted, and coupling them with one another in such a way that upon introduction of the sheet material, the latter is arranged in a fixed position centeredly in the office accessory. It is of course also possible to embody both side stops displaceably and, if applicable, to immobilize them subsequently in the various positions, so as then to place the sheet material in reproducible fashion into the office accessory.

### BRIEF DESCRIPTION OF THE FIGURES

The invention is illustrated, with reference to an exemplifying embodiment, in the drawings, in which:

FIG. 1 is a plan view of an office accessory according to the present invention with a ruler folded in;

FIG. 2 is a perspective depiction of the office accessory according to FIG. 1, with a hole punch;

FIG. 3 depicts the hole-punching operation; and

FIG. 4 depicts the cutting operation.

### DETAILED DESCRIPTION OF THE PREFERRED EMBODIMENT(S)

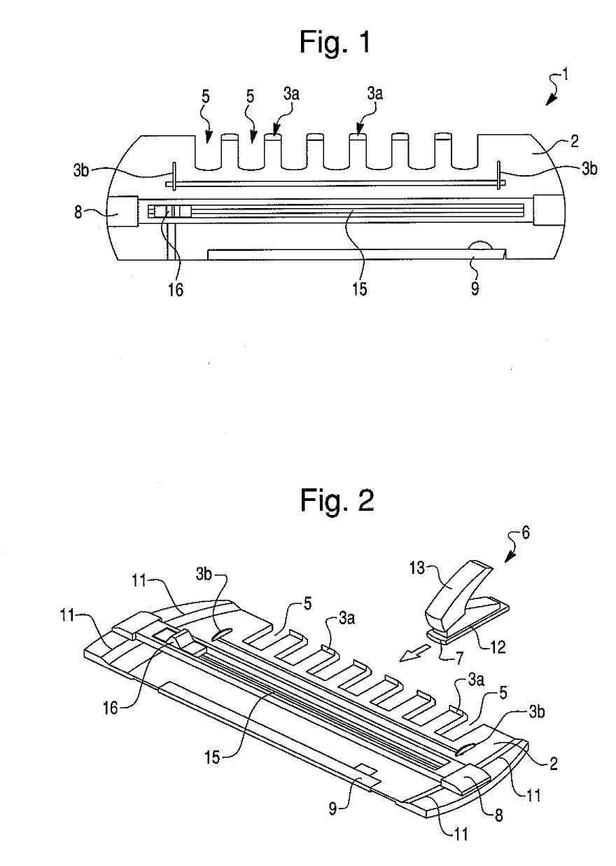

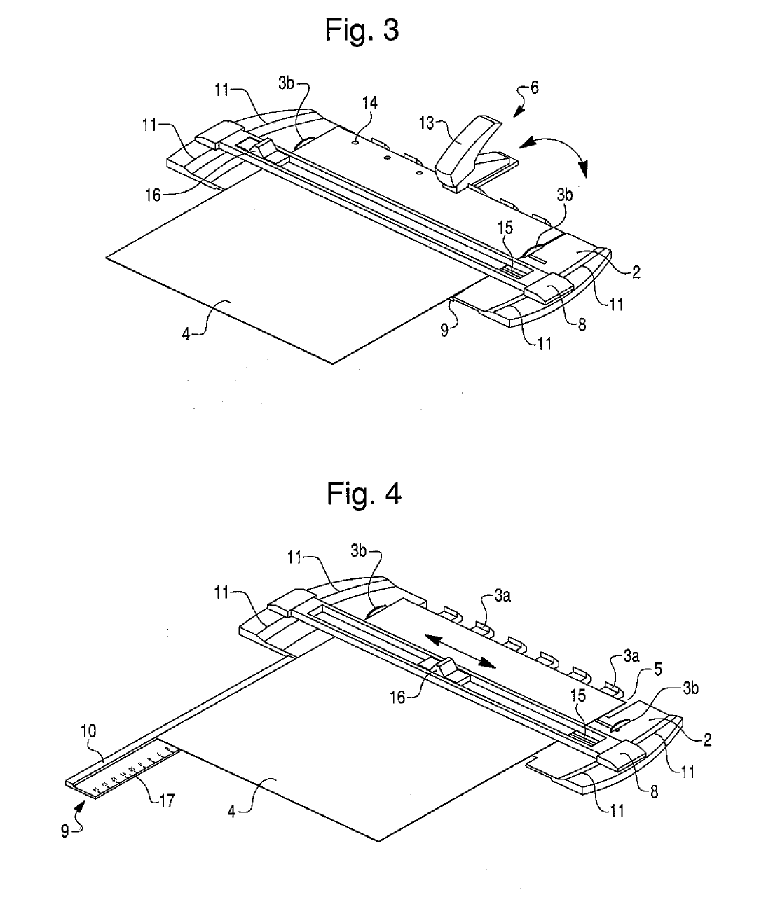

Office accessory 1 depicted in FIG. 1 comprises a substantially rectangular base 2. Arranged on the upper (in this view) longitudinal side of office accessory 1 is a stop 3a for positionally accurate positioning of sheet material 4 in office accessory 1. Further positioning is made available by displaceably arranged side stops 3b. Base 2 is equipped in its edge region with seven recesses 5 into which a punching apparatus 6 is insertable for hole-punching of sheet material 4 (as shown in FIGS. 2 and 3).

Recesses 5 are shaped so that they form engagement elements, embodied in complementary fashion to punching apparatus 6, for reproducible positioning of punching apparatus 6 in different hole-punching positions. In the present exemplifying embodiment, recesses 5 are dimensioned exactly so that a front end portion 7 of punching apparatus 6 (shown in FIG. 2) can be inserted into them so that end portion 7 completely fills up a recess 5 in the inserted state.

A cutting device 8 for trimming the sheet material is provided on office accessory 1 below stop 3a. In this exemplifying embodiment, cutting device 8 is embodied as a rotary cutting device. Arranged on the lower (in this view) longitudinal side of office accessory 1 is a fold-out measurement device 9 in the form of a ruler, on which is embodied a second stop 10 for more-accurate alignment of sheet material 4, for example when setting a specific edge length.

For introduction of a punched hole, sheet material 4 is placed into office accessory 1 as shown in FIG. 3, one edge or periphery of sheet material 4 being slid toward stops 3a, 3b, 10 and coming into contact against them. In this position, edge portions of sheet material 4 that are located over recesses 5 remain freely accessible, so that the edge portions of sheet material 4 can be processed in those regions by means of punching apparatus 6.

Also embodied in bed 2 is a guide bar 11 for cutting device 8, so that cutting device 8 can be displaced parallel to stop 3a and so that a spacing between stop 3a and cutting device 8 can thereby be modified. This makes it possible to set the length of the edge perpendicular to the edge of sheet material 4 located at stop 3a by adjusting cutting device 8, and to perform the cutting operation, with no need to move sheet material 4 within office accessory 1 for that purpose.

FIGS. 3 and 4 illustrate the individual processing steps performable by way of office accessory 1 for the processing of sheet material 4. Firstly, for hole-punching, sheet material 4 (here in the form of a sheet of paper) is placed into office accessory 1 and slid in until the sheet of paper comes into contact against stop 3a or 3b. Punching apparatus 6 is then inserted into a first recess 5 in order to equip an exposed edge portion of sheet of paper 4 with a punched hole.

As shown in FIG. 3, hole-punching of sheet material 4 proceeds from left to right. For this purpose, specifically, an exposed edge portion of sheet of paper 4 is inserted into a slot 12 (FIG. 2) of punching apparatus 6 when front end portion 7 of punching device 6 is positioned by insertion into recess 5. A lever 13 of punching apparatus 6 is then pushed down, with the result that a punching element (not depicted further) of punching apparatus 6 penetrates through the exposed edge portion of sheet of paper 4 so that a punched hole 14 is produced in the sheet of paper. Front end portion 7 of punching apparatus 6 is then inserted from first recess 5 into the next recess 5 in order to hole-punch, in the same fashion, a further exposed peripheral portion of sheet of paper 4 that is exposed above said recess 5. The maximum number of reproducible punched holes 14 is equal to the number of recesses 5 provided.

The cutting operation is depicted schematically in FIG. 4. To allow trimming of sheet material 4 inserted into office accessory 1, it is firstly brought into contact against stops 3a, 3b and thereby aligned in office accessory 1. Rotary cutting device 8 comprises a guide bar 15 that extends at a distance from bed 2 parallel to stop 3. A knife carriage 16 is guided on guide bar 15 displaceably in the direction of the longitudinal axis of guide bar 15. Said carriage can be shifted back and forth manually. A circular knife (concealed here by a knife housing) is mounted on knife carriage 16 rotatably about a horizontal axis extending transversely to the longitudinal axis of guide bar 15. The rotary knife projects downward beyond the knife housing. In this exemplifying embodiment, cutting device 8 is guided in vertically displaceable fashion and can be raised 12 mm in order to simplify the insertion of sheet material 4 into a gap between guide bar 15 and bed 2.

To allow definition of the length of the edge region of sheet material 4 perpendicular to cutting direction 8, without requiring for that purpose a further displacement of sheet material 4 within office accessory 1, in this exemplifying embodiment further guide bars 16 are embodied in bed 2 perpendicular to the alignment of stop 3 and of guide bar 15 of cutting device 8; these enable cutting device 8 to be displaced parallel to stop 3 and thereby allow the spacing between stop 3 and cutting device 8 to be set in reproducible fashion.

In the exemplifying embodiment shown here, a further stop edge 10 is provided on the fold-out ruler 9, thereby making it possible for sheet material 4 to be trimmed with edge regions aligned parallel to one another without needing, for that purpose, to be in contact with stop 3. The result of this is that the length of the edge regions to be selected perpendicular to stop 3 can be selected even more flexibly. A scale 17 in centimeters is provided on fold-out ruler 9. To allow setting of a specific trimming length for sheet material 4, and so that this length can also be easily read off from ruler 9 without conversion steps, ruler 9 is mounted displaceably perpendicular to the alignment of cutting device 9, so that scale 17 can be slid with its starting value against the edge region of sheet material 4. In order to cut sheet material 4, knife carriage 16 is displaced under slight pressure within guide bar 15, the circular knife (not depicted) located therebelow executing a rotary movement and thereby cutting the sheet material. The trimmed sheet-material portion resting on base 2, and the cut-off sheet-material portion, remain behind.

1. An office accessory (1) for processing sheet material (4), having a bed (2) for receiving the sheet material (4), having at least one stop (3a) for positionally accurate positioning of the sheet material (4), and having a punching apparatus (6), the bed (2) and punching apparatus (6) comprising complementary engagement elements (5) for reproducible positioning of the punching apparatus (6) in different punching positions in the region of the stop (3a),
wherein the office accessory (1) comprises at least one cutting device (8) for trimming the sheet material (4).

2. The office accessory (1) according to claim 1, wherein the cutting device (8) is a guillotine cutting device.

3. The office accessory (1) according to claim 1, wherein the cutting device (8) is a rotary cutting device.

4. The office accessory (1) according to claim 1, wherein the cutting device (8) is a blade cutter.

5. The office accessory (1) according to claim 1, wherein a holddown for pressing the sheet material onto the bed (2) is arranged adjacent to the cutting device (8), the holddown being movable between a raised starting position and a pressing position offset toward the sheet-material support surface.

6. The office accessory (1) according to claim 1, wherein the cutting device (8) is aligned parallel to the stop (3a).

7. The office accessory (1) according to claim 1, wherein the cutting device (8) is aligned perpendicular to the stop (3a).

8. The office accessory (1) according to claim 1, wherein the cutting device (8) is guided displaceably parallel to the stop (3a).

9. The office accessory (1) according to claim 1, wherein the cutting device (8) is alignable relative to the stop (3a) at an angle that is modifiable by way of an adjustment mechanism.

10. The office accessory (1) according to claim 1, wherein the stop (3a) is guided displaceably parallel to the cutting device (8).

11. The office accessory (1) according to claim 1, wherein the cutting device (8) is raisable out of a lower cutting position into an upper starting position, and is lowerable therefrom back into the cutting position.

12. The office accessory (1) according to claim 1, wherein the cutting device (8) is inaccessible from the end faces of the cutting device (8).

13. The office accessory (1) according to claim 1, wherein the cutting device (8) is guided in vertically displaceable fashion in the region of its end faces.

14. The office accessory (1) according to claim 11, wherein the cutting unit (8) is raisable 5 to 20 mm.

15. The office accessory (1) according to claim 11, wherein the cutting device (8) is fastenable in the cutting position, at its vertically movable end(s), by means of a blocking device or devices.

16. The office accessory (1) according to claim 15, wherein the or each blocking device is embodied as a snap device into which the cutting device (8) snaps automatically and disengageably upon movement into the cutting position.

17. The office accessory (1) according to claim 16, wherein the snap device comprises an actuation slider with which the snap device is disengageable.

18. The office accessory (1) according to claim 1, wherein the complementary engagement elements (5) are embodied in a template that is insertable into a holder embodied in the office accessory (1).

19. The office accessory (1) according to claim 1, wherein it comprises a measurement device (9) for determining the dimensions of the sheet material (4).

20. The office accessory (1) according to claim 19, wherein the measurement device (9) is a ruler, in particular mounted in fold-out fashion on the office accessory (1), or a measuring roller having a length indicator.

21. The office accessory (1) according to claim 19, wherein the measurement device (9) is mounted displaceably relative to the stop (3).

22. The office accessory (1) according to claim 1, wherein at least one side stop (3b) is arranged on the bed (2) for positioning of the sheet material (4).

23. The office accessory (1) according to claim 22, wherein the side stop (3b) is arranged displaceably on the bed (2).
